(19) United States
(12) Patent Application Publication
(10) Pub. No.: US 2025/0295483 A1
(43) Pub. Date: Sep. 25, 2025

(54) Device for Brushing Teeth and Stimulating Gums

(71) Applicant: Henry H. Bilge, Fort Lee, NJ (US)

(72) Inventor: Henry H. Bilge, Fort Lee, NJ (US)

(21) Appl. No.: 18/238,350

(22) Filed: Aug. 25, 2023

(51) Int. Cl. A61C 17/34; A46B 7/04; A46B 13/00; A46B 13/02; A61C 17/22

(52) U.S. Cl. CPC A61C 17/3436; A46B 7/044; A46B 13/001; A46B 13/02; A61C 17/221; A61C 17/222; A61C 17/224; A61C 17/225

(57) ABSTRACT

The disclosed device is a power or electrical toothbrush having a central drive motor power at least one shaft using a loop. There are at least 2 to four shafts that support removable drums having brush bristles. The two to four shafts are rotated with ribbon connection to at least one central shaft. The drums are removable and represent the brush head of the disclosed device.

### FIELD OF THE INVENTION

The present invention relates to devices used to clear food residue and plaque from the surface of teeth.

### BACKGROUND OF THE INVENTION

Proper teeth hygiene is required for the health of the teeth and for the overall health of the person. Teeth are the first barrier separating the outside world from user's digestive system. Therefore, a mouth full of teeth would mean that the digestive system can focus more on breaking down food into basic molecules and less on grinding food, which is the work of the teeth.

Basic oral hygiene starts with a good toothbrush. The purpose of basic hygiene is to first clear away food residue and second to control and even remove calcium and plaque buildup on the surface of the teeth and along the gumline. The best way to brush teeth is in a rotating motion, with brush bristles passing over the same surface multiple times before moving on to the next tooth.

Most manual and electric toothbrushes contain a small head that is design to cover one tooth at a time. The head is attached to a handle. The user then passes the head of the brush against each tooth individually in a circular and reciprocal motion. An electric brush is designed to make the process faster and more efficient by automating either the circulation or the reciprocity of the basic manual process. However, proper hygiene using a manual or an automatic brush still takes some time to achieve. Therefore, the effectiveness of the single head brushes is diminished by user's being in a rush to end the process and move on with their days or nights. An additional downside of a single head brush is that pressure and exposure at each tooth will vary based on where the tooth is positioned inside the oral cavity. Molars for example tend to receive less attention and suffer from decreased pressures since they are harder to get to than the incisor and canines, which are at the opening of the mouth.

An alternative solution has been developed where a single brush head cleans several all the majority of the lower or upper jaw. While these devices dramatically reduce the time it takes to effectively brush the teeth, a single frame brush is designed to accommodate most mouth types and sizes, and therefore it won't fit any one mouth size or type evenly or adequately. Therefore, there is presently an strong and unfulfilled need to provide a single frame brush that adjusts the to the size and shape of a particular jaw.

### SUMMARY OF THE INVENTION

The disclosed device is a power toothbrush having a handle forming part of the central frame. The handle further comprises the power source, which is preferably a battery that may be recharged through a port, and a control unit. The control unit controls the motor and is enable via a switch. The motor may preferably drive the loop in a clockwise or counterclockwise direction, thereby directly driving the drum in the same direction as the loop the loop is preferably a ribbon having skid resistant properties, such as rubber or plastic. The loop may also be a chain, or a belt. The disclosed toothbrush describes two frames a first frame and a second frame mounted one above the other in a parallel or a parallel but offset orientation with each other. The first frame is comprised of a first base wall having a first elevational arm and a second elevational arm. A first shaft, preferably made of bendable and/or flexible material extending from the first elevational arm to a terminal elevational arm in either direction past the first elevational arm along the length of the first base wall. A second shaft, preferably made of bendable and/or flexible material extending from the second elevational arm to a terminal elevational arm in either direction past the first elevational arm along the length of the first base wall.

The second frame is comprised of a second base wall having a third elevational arm and a fourth elevational arm. A fourth shaft, preferably made of bendable and/or flexible material extending from the third elevational arm to a terminal elevational arm in either direction past the third elevational arm along the length of the second base wall. A fifth shaft, preferably made of bendable and/or flexible material extending from the fifth elevational arm to a terminal elevational arm in either direction past the fifth elevational arm along the length of the second base wall.

The first frame extends laterally from the first and second elevational arm in the first and second direction, such that its distal ends are in parallel and spaced apart configuration with each other. The second frame extends laterally from the fourth and third elevational arm in the first and second direction, such that the distal ends of the second base wall are in parallel and spaced apart configuration with each other.

The first and second frames are separated by removable parallel brackets. Each bracket having a first portion, a second portion and a first wall in between. The bottom surfaces of the first and second base wall are removably attaching to each of the removable parallel brackets, and the removable parallel brackets are then situated in a parallel and spaced apart association to each other, with the central frame, comprising a battery, a control device and at least one motor then sliding in between the parallel brackets and engaging the central shaft to enable rotation of the central shaft with the second, third, forth and fifth shafts.

Each of the second, third forth and fifth shafts connecting to the central shaft via loop, which is preferably a ribbon and each of the second, third forth and fifth shafts removably mounting a plurality of drums or drum segments that are configured to be positioned along the length of the aforementioned shafts. Each of the drums in turn has multiple rows of bristles that are removable.

Each of the second, third, fourth and fifth shafts can in turn be adjusted in the direction towards or away from the first or second base walls using intermediate arms that are attached to the first or second base walls using fasteners that can be loosened or tightened depending on the direction of adjustment. The bottom end of such intermediate arm is connected to a connection point and the top end is made of preferably a pincer clamps to removably hold the shafts.

### BRIEF DESCRIPTION OF THE DRAWINGS

FIG. 1 shows one embodiment of the present invention showing a power toothbrush with a single roller.

FIG. 1A. is a detailed diagram of the embodiment shown in FIG. 1, further showing the central shaft.

FIG. 2 is a detailed diagram of the embodiment shown in FIG. 1.

FIG. 3. is an embodiment of the drive components enabling the operation of a toothbrush embodiment having first and second frames.

FIG. 4 is a cross sectional figure of the embodiment shown in FIG. 3.

FIG. 5A is a diagram of one embodiment of the central frame.

FIGS. 5B, 5C, and 5D demonstrate the various embodiments of the central frame.

FIGS. 6 and 7 are diagrams of the full embodiment a toothbrush having first and second frames.

FIG. 8 demonstrates that the drums mounted along the first and second frames.

FIGS. 8A and 8B demonstrate the removability and modular operation of the disclosed apparatus, as well as the detailed of individual sections.

FIG. 9 is a diagram of the toothbrush having missing drums and demonstrating adjustment functionality.

FIG. 10 demonstrates gaps between the first or second base wall and the shafts existing to rotate the removable drums.

FIGS. 11 and 12 are diagrams excluding the shafts and just demonstrating the elevational arms and the base walls.

### DESCRIPTION OF THE PREFERRED EMBODIMENTS

The preferred embodiments of the present invention will now be described with reference to the drawings. Identical elements in the various figures are identified with the same reference numerals.

Reference will now be made in detail to embodiment of the present invention. Such embodiments are provided by way of explanation of the present invention, which is not intended to be limited thereto. In fact, those of ordinary skill in the art may appreciate upon reading the present specification and viewing the present drawings that various modifications and variations can be made thereto.

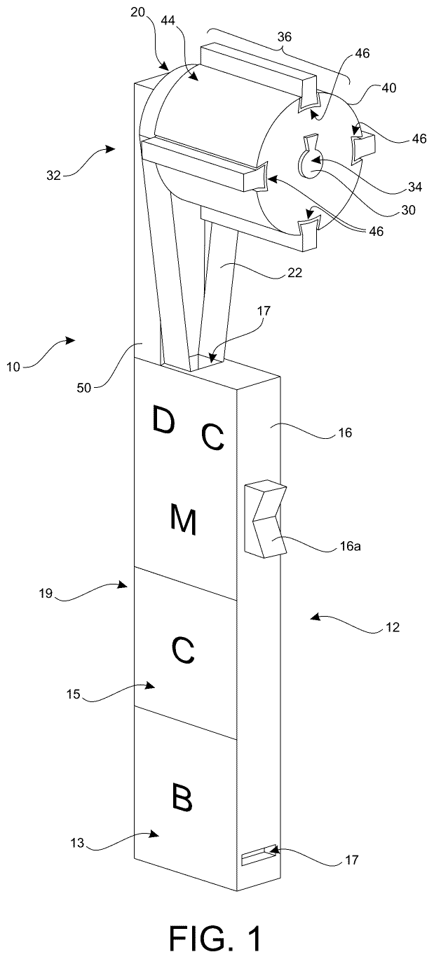

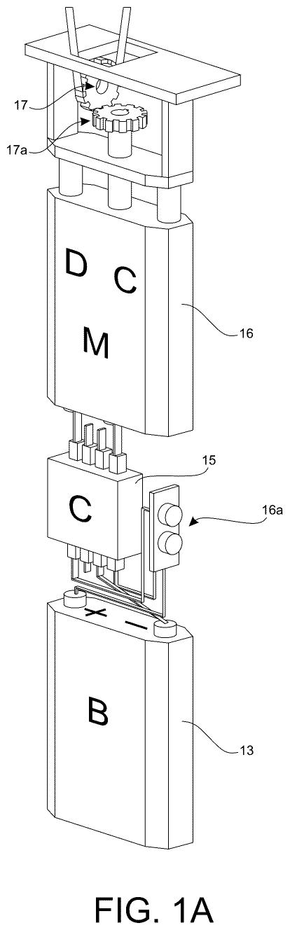

FIGS. 1 and 1A demonstrate one embodiment of an electric or power toothbrush 10 comprising a central frame 12, said central frame 12 having a motor 16 rotating a central shaft 17. The central shaft 17 couples with a shaft a a second shaft 30 that is rotationally mounted onto the first elevational arm 50. Rotational mounting refers the loop 22, which is preferably a ribbon, a belt or a chain, and which rotates with the rotation of the central shaft 17, causing the second shaft 30 to rotate as well, The first elevational arm 50 projects out from the central frame 12. The second shaft 30 has a first end 32 and a second end 34. The first end 32 of the second shaft 30 is held within a socket (52) or an opening in the first elevational arm 50. The first elevational arm 50 extends away from the central frame 12 in any direction away from the central frame, not just above the frame 12 that is shown in FIGS. 1 and 1A. The loop 20 may be mounted on a remote wheel 20 that is mounted onto a second shaft 30, or the loop may be mounted directly onto the second shaft 30. The second shaft 30, and in particular, the length 36 between the first end 32 and the second end 36 serving as a spindle for the remote wheel 20, and at least one drum 40 which is configured to slide over the second shaft 36. The outer surface 44 of the drum 40 preferably contains a plurality of grooves 46 housing a plurality of bristles 42. Alternatively, the bristles may emerge directly from the outer surface 44. Additional drums 40 may be positioned adjacently to the drum shown along the side of the second end 34 of the second shaft 30 or to the other side of the first elevational arm 50 along the side of the first end 32 of the second shaft 30.

Also shown in FIG. 1 is the handle 19 forming part of the central frame 12. The handle 19 further comprises the power source 13, which is preferably a battery that may be recharged through a port 17, and a control unit 15. The control unit 15 controls the motor 16 and is enable via a switch 16a. The motor 16 may preferably drive the loop 22 in a clockwise or counterclockwise direction, thereby directly driving the drum 40 in the same direction as the loop 40 the loop 40 is preferably a ribbon having skid resistant properties, such as rubber or plastic. The loop 40 may also be a chain, or a belt.

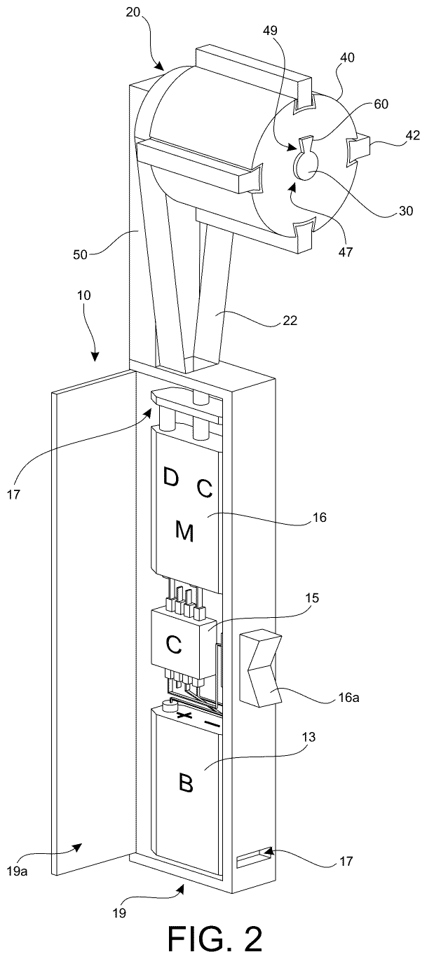

FIG. 2 demonstrates the internal structure of the handle 19, with the protective panel 19a opened to reveal a power unit 13, connected to a controller 15, being enabled by an external switch 16a. The controller directs motor 16 to rotate the central shaft (17), which rotates the remote wheel 20 via loop 22. The remote wheel 20 is mounted adjacent to the first elevational arm 50. Mounting onto the second shaft 30 is the rotating drum 40 that comprises of a plurality of bristles 42. The second shaft 30 fits within the central channel 47 of the drum 40. A protruding ridge 60 preferably extends over the entire length 36 of the second shaft 30. The protruding ridge 60 fits within the groove 49 of each of the at least one drum 40 and locks the drum in a rotational coupling that matches the rotation of the second shaft 30. It should be noted, that the at least one remote wheel 20 is preferably also comprised with a central channel (47) and the groove (49) to as the remote wheel 20 is also mounted over the second shaft 30. It should be appreciated to the one skilled in the art that while one drum 40 is shown, the second shaft 30 may be longer and additional adjacent drums may be mounted next to the shown drum 40. Furthermore, the second end 32 may project out to the other side of the first elevational arm 50 and support additional one or more drums 20.

FIG. 2A demonstrates an elevational drawing of one of the at least one drums 40. The drum 40 is comprised of a circular outer wall 44 that may be enclosed or open on its sides 41. A plurality of grooves 43 are formed along the surface 45 of the outer wall 44. The groves 43 are intended to removably hold a row or cluster of bristles 42. In this fashion, to replace worn bristles, a user need not change or remove a drum off of a shaft of the disclosed device but can simply remove the entire bunch of bristles 42 and replace it with a new bunch of bristles 42. The Grove 43 and the base 47 of the bristle bunch 42 are fitted together in a dovetail coupling, or in any other durable, yet easily removable coupling. The outer wall 44 is preferably made of flexible or bendable materials.

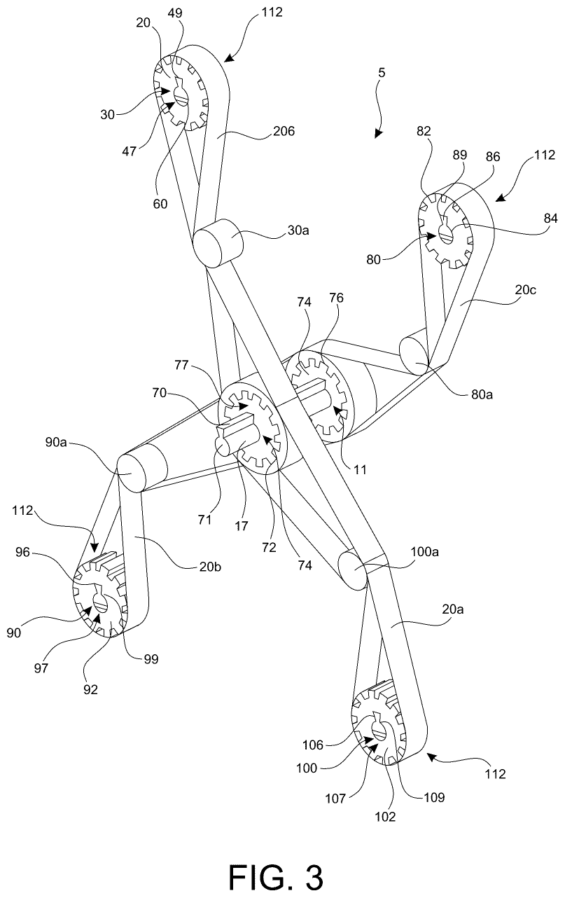

FIG. 3 describes the drive section 5 of the disclosed device. Shown is the central shaft 17. Extending over the length of the central shaft 17 is the ridge 70. Shaft 17 is encased in an electric motor (16) at one or either ends 71 of the central shaft 17, or along the length of the central shaft 17. The central shaft connects to the at least one remote wheel 20 through a rotating loop 20b. The central shaft 17 connects to the additional remote wheel 82 of the third shaft 80 via a rotating loop 20c. Central shaft 17 connects to the remote wheel 92 mounted on the fourth shaft 90 via the loop 20d. And the central shaft 17 is shown connecting to remote wheel 102 that is mounted on the fifth shaft 100 through a loop connection 20a. Alternatively, the loop 20b is looped directly around the second shaft 30, or the loop 20c is looped directly around the third shaft 80, or the loop 20c is looped directly around the fourth shaft 90, or the loop 20d is looped directly around the fifth shaft 100.

It is preferred that the loop connection 20b and 20a represent a single or separate loops that couple the second shaft 30 and the fifth shaft 100 over the central shaft 17. It is further preferred that the loop connections 20c and 20d represent a single or separate loops that couple together the third shaft 80 and the fourth shaft 90 over the central shaft 17. The loop connections 20b and 20a may alternatively be made over the first central wheel 74, while the loop connections 20c and 20d, linking the third and fourth shafts 80 and 90 respectively may be mounted over the second central wheel 74.

It is preferred that the loops 20c and 20d are spooled in a way that causes the second shaft 30 and the fifth shaft 100 to rotate in opposite directions. It is further preferred that the loops 20a and 20b are spooled in a way that causes the third shaft 80 and the fourth shaft 90 to rotate in opposite directions. To assist in this respect and in the rotation the each of the loops 20a-20d are connecting through at least one spool peg 30a, 80a, 100a and 90a.

Notably shown in FIG. 3 is a protruding ridge, with a corresponding groove on either a remote wheel a central wheel or a rotating drum. Thus, the central shaft 17 comprises a protruding ridge 70 with a corresponding groove 77 on both the first central wheel 72 and the second central wheel 76. The second shaft 30 demonstrates a protruding ridge 60 and a corresponding grove 49 in the central channel 47. The third shaft 80 preferably comprises a protruding ridge 86 with a corresponding groove 89 in the center channel 84. The fourth shaft 90 comprises a protruding ridge 96 with a corresponding groove 99 of the central channel 97. And the fifth shaft 100 comprises a protruding ridge 106 corresponding to a groove 109 within the central channel 107.

While only one protruding ridge (60, 70, 86, 96 and 106) is shown, another embodiment may be comprised of fewer or additional protruding ridges. Each protruding ridge (60, 70, 86, 96 and 106) is shown to be in a dovetail coupling with the respective grooves (49, 77, 89, 99, and 109). However, any or all protruding ridges may be set forth in a different shape than shown with a correspondingly shaped groove of either the remote wheel (20, 82, 92, and 102) or first and second center wheels (72 and 76). The crown 112 of each or some of the remote wheels (20, 82, 92, and 102) may further comprise teeth or another tread surface. Similarly, the crown 74 of the first and second central wheels 72 and 76 may each be comprised of teeth, or another treaded surface.

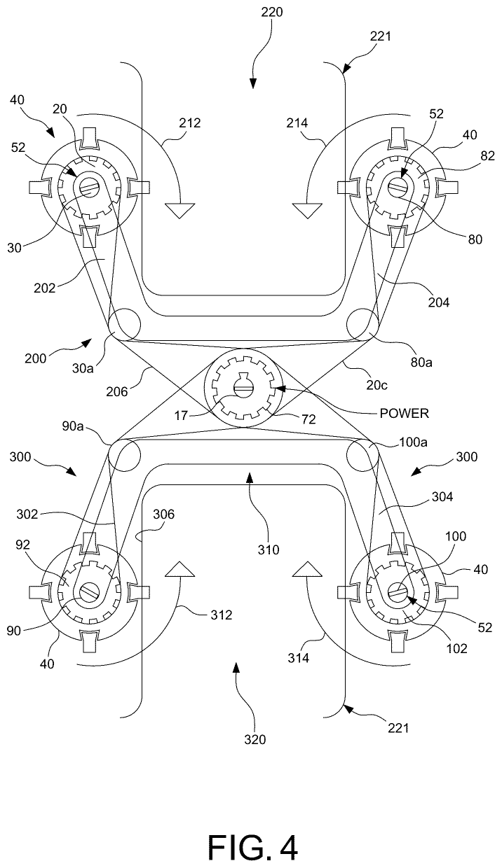

FIG. 4 is a sectional diagram showing the first frame 200 and the second frame 300. The first frame 200 comprises the first base wall 210 supporting the first elevational arm 202 and a the second elevational arm 204. The first elevational arm 202 and the second elevational arm 204 extending at an angle from the first base wall 210 in a parallel and spaced apart orientation with respect to each other and separated by the first base wall 210.

The second frame 300 is comprised of the third elevational arm 302 and a fourth elevational arm 304, which are mounted along the opposing edges of the second base wall 310. The angle of the second shaft 30 and the third shaft 80 may be varied in the direction 206 by using an attachment point fastener (360). The angle of the second shaft 30 and the third shaft 80 is varied to accommodate different teeth sizes and jaw shapes. Similarly, the angle of the fourth shaft 90 and the fifth shaft 100 may be varied in the direction 306 by using an attachment point fastener (360). The angle of the fourth shaft 90 and the fifth shaft 100 is varied to accommodate the different teeth sizes and jaw shapes of a user.

The loop 20b is shown connecting the remote wheel 20 mounted on the second shaft 30 through the central shaft 17 and the first central wheel 72 to the fifth shaft 100 and the remote wheel 102. The loop 20b is shown spool around the spool pegs 30a and 100a to clear the corner of the first frame 200 and the second frame 300, respectively. The loop 20c is shown connecting the remote wheel 82 mounted on the third shaft 80 through the central shaft 17 and the (second) central wheel (76) to the third shaft 90 and the remote wheel 902. The loop 20c is shown spooling around the outside of the spool pegs 80a and 90a to clear the corner of the first frame 200 and the second frame 300, respectively.

The teeth 221 of an upper or lower jaw are inserted into gap 220 between the second shaft 30 and the third shaft 80, with the teeth 221 of the opposite jaw being inserted into gap 320 between the fourth shaft 90 and the fifth shaft 100. In each case the first base wall 210 and the second base wall 310 is then adjacent to or in contact with a cutter edge of teeth, thus the preferred rotation of the drums 40 mounted on the second shaft 30 is in the direction 212 or toward the first base 210; the preferred rotation of the drums 40 mounted on the third shaft 80 is in the direction 214 or toward the first base 210; the preferred rotation of the drums 40 mounted on the fourth shaft 90 is in the direction 312 or toward the second base 310; and the preferred rotation of the drums 40 mounted on the fifth shaft 100 is in the direction 314 or toward the second base 310. In all cases this is the preferred rotation, and is considered a gum saving rotation since directs debris and food residue away from the gum line, thus preventing injury and abrasion of the gums and additionally dissipates plaque building materials and germs away from the gums. The rotation of the drums may be reversed ty reversing the rotation of the central shaft 17. Thus at any one time, the drums 40 on the first frame 200 are rotating in the opposite direction of the second frame 300.

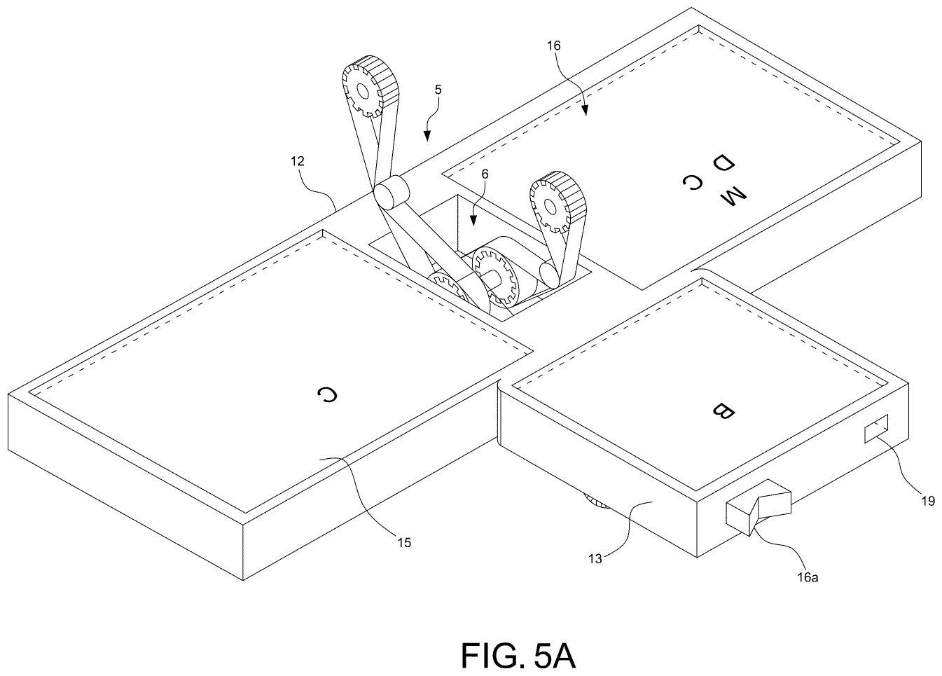

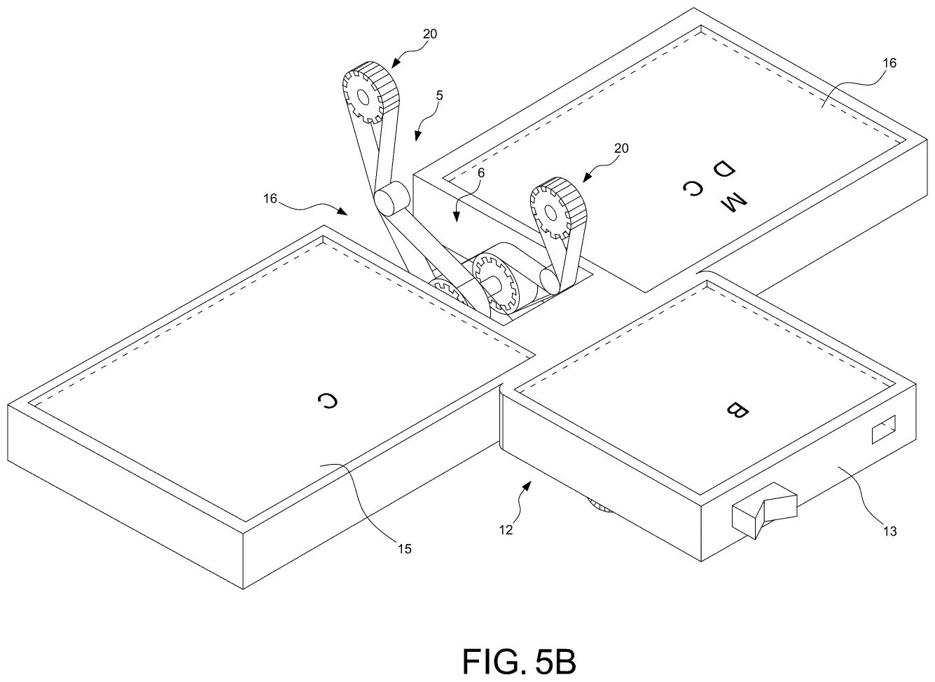

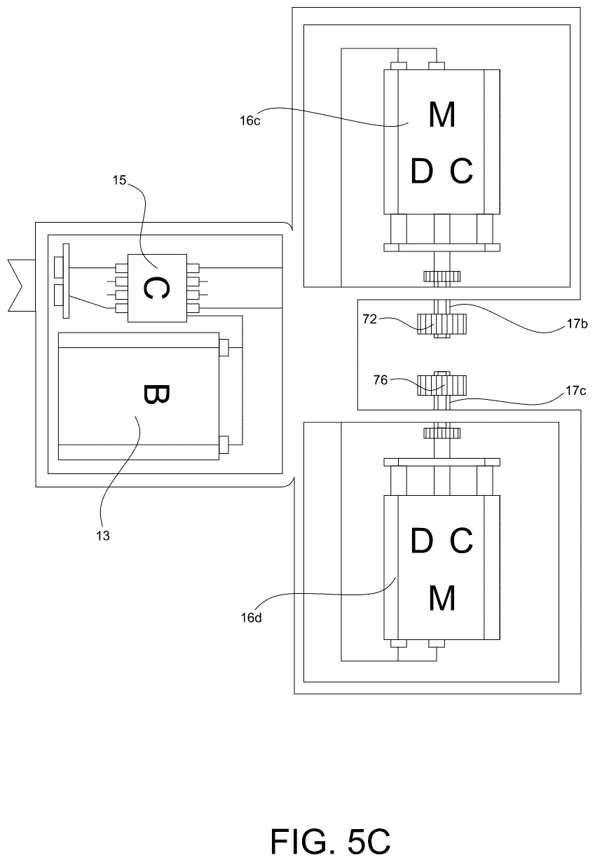

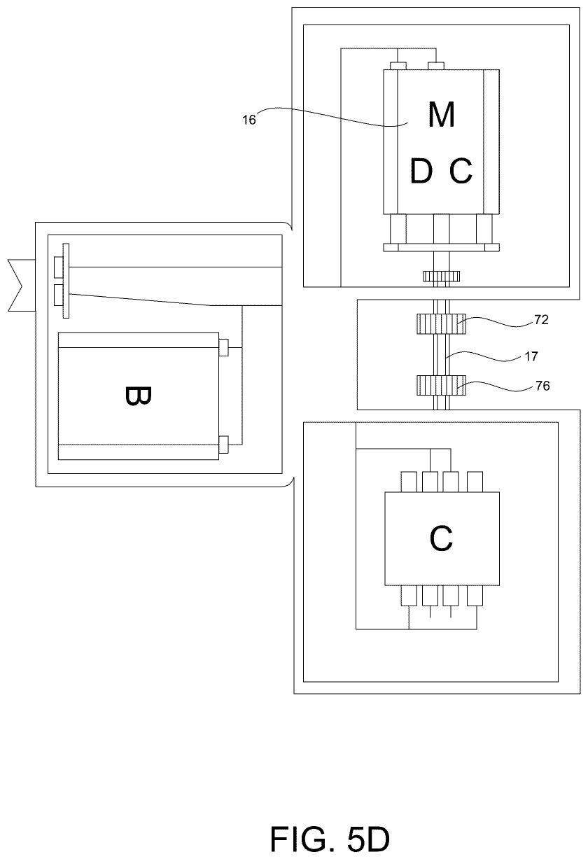

FIG. 5A describes an embodiment of central frame 13. The central frame 13 is comprised of a power unit 13, the control unit 15 and at least one motor 16, which converge around the gap 6 housing the drive section 5.

FIG. 5B demonstrates one embodiment of the central frame 12 showing the at least one motor unit 16, the power unit 13 and the controller unit 15. The drive section 5 featuring the central shaft (17) enabling rotation of the wheels 20 is within a gap 6 that contains an opening 11. The opening 11 permits the frame 12 to be removed and inserted in between the first and second frames 200 and 300 respectively.

FIGS. 5C and 5D describe additional embodiments of the central frame 12. FIG. 5C shows the frame 12 having the controller 15 share the compartment with the power pack 13. This embodiment features two motors 16, each of which rotate the central shafts 17b and 17c. The central shafts 17b and 17c rotate independently of one another. The central shaft 17b may further comprise the first central wheel 72, while the central shaft 17c may further comprise the second central wheel 76. The location of the first and second central wheels 72 and 76, respectively with respect to the central shafts 17b and 17c are interchangeable. In FIG. 5D one motor 16 rotates the central shaft 17. The central shaft 17 may further comprise the first central wheel 72 and the second central wheel 76. In all embodiments of the motor shown in FIGS. 5. 5B, 5C and 5D, the motors shown may cause the central shafts 17 to spin or rotate in a continuous fashion, or may instead be capable of an intervalled rotation. An intervalled rotation induces a rotation of several degrees at a time, pausing and then rotating by a few more degrees. Thus the central shaft 17 rotates in jerks of varying duration rather than in a continuous rotation. In another embodiment of a motor, the intervalled and continuous rotation may be combined.

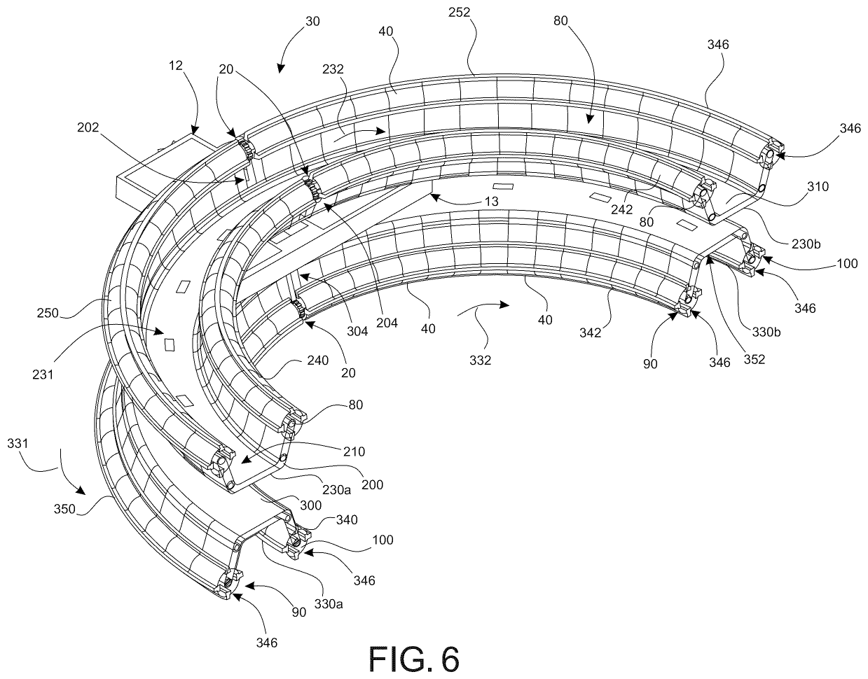

FIG. 6 describes the power toothbrush 10 comprising a first frame 200 and a second frame 300. The first frame 200 and said second frame 300 are each held by the central frame 12, which is disposed in between the first frame 200 and the second frame 300. The first frame 200 having the first base wall 210 supporting the first elevational arm 202 and a second elevational arm 204.

The first and the second elevational arms 202 and 204, respectively, being in a parallel and spaced apart orientation with each other, separated by said first base wall 210. The first base wall 210 extending laterally in the first direction 231 and in a second direction 232 from the first and the second elevational arms 202 and 204, respectively. The distal ends 230a and 230b of the first base wall 210 are coordinated to be in parallel and spread apart association with each other. The first segment 250 of the second shaft 30 is shown extending from the first elevational arm 202 until terminal point 346. The second segment 252 of the second shaft 30 extending from the first elevational arm 202 until a terminal point 346 along said second direction 232 of said first base wall 210. The first segment 240 of the third shaft 80 is shown extending from the second elevational arm 204 until a terminal point 346 along the first direction 231 of the first base wall 210, and the second segment 242 of the third shaft 80 extending from the second elevational arm 204 until the terminal point 346 along the second direction 232 of the first base wall 210.

FIG. 6 further demonstrates the second frame 300 having the second base wall 310. The second base 310 wall supporting the third elevational arm (302) and a fourth elevational arm 304. The third and the fourth elevational arms 302 and 304 being in a parallel and spread apart orientation with each other, separated by the second base wall 310. The second base wall extending laterally in the first direction 331 and in a second direction 332 from the third and the fourth elevational arms (302) and 304 respectively. The distal ends 330a and 330b of the second base wall 310 in the first direction 331 and in the second direction 332 of the second base wall 310 being in parallel and spread apart association with each other. The 350 first segment of the fourth shaft 90 extending from the third elevational arm (302) until a terminal point 346 along the first direction 331 of the second base wall 320. Similarly, the second segment 352 of the fourth shaft 90 extending from the third elevational arm (302) until the terminal point 346 along said second direction 332 of the second base wall 310. Furthermore, the first segment 340 of the fifth shaft 100 extending from the fourth elevational arm 404 until the terminal point 346 along the first direction 331 of the second base wall 310 and the second segment 342 of the fifth shaft 100 extending from the fourth elevational arm 304 until the terminal point 346 along the second direction 332 of the second base wall 320.

The first frame 200 and the second frame 300 may be directly over each above each other or slightly set off either front to back or side to side or both. The direct orientation of the first frame 200 and the second frame 300 may be controlled by how first frame 200 and the second frame 300 are mounted on the central frame 12.

Still referring to FIG. 6. the first and second segments 250 and 252 of the second shaft, the first and second segments 240 and 242 of the third shaft 80, the first and second segments 350 and 352 of the fourth shaft 90, and the first and second segments 340 and 342 of the fifth shaft 100 are made of an elastic material. Each of the segments (240, 242, 250, 252, 350, 352, 340, and 342) may be a single shaft in structural sense or may be assembled a plurality of sequentially connecting shafts.

The plurality of rotating drums 40 are selectively mounted along the length of the second shaft 30 the third shaft 80, the fourth shaft 90, or the fifth shaft 100. Furthermore, each of the shafts (30, 80, 90, 100) having a remote wheel 20. The cleaning surface of the disclosed brush is comprised of a plurality of drums 40 mounted sequentially over the disclosed shafts (30, 80, 90, 100).

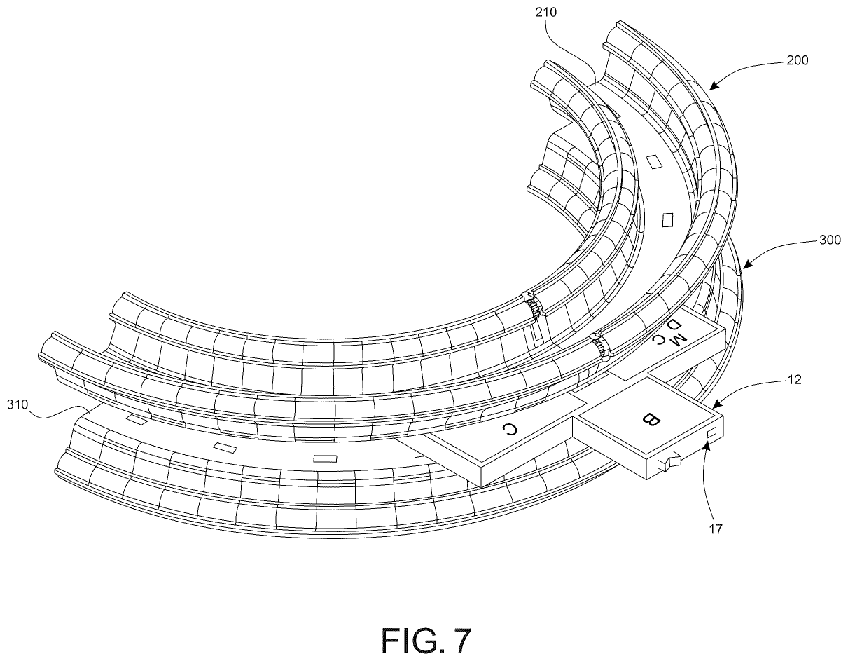

FIG. 7 shows the device 10 from a frontal angle, with the center frame 12 shown between the first and second frames 200 and 300. The center frame 12 may function as a handle.

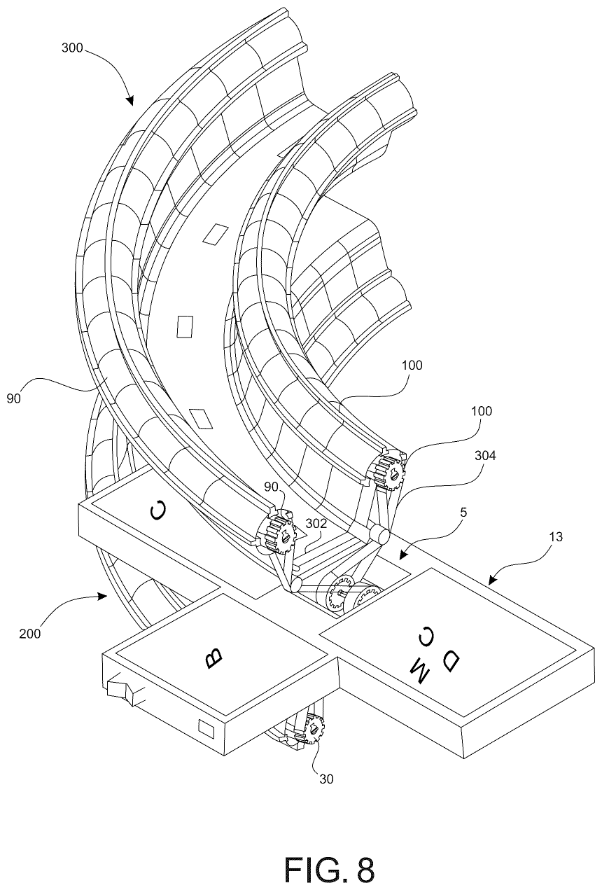

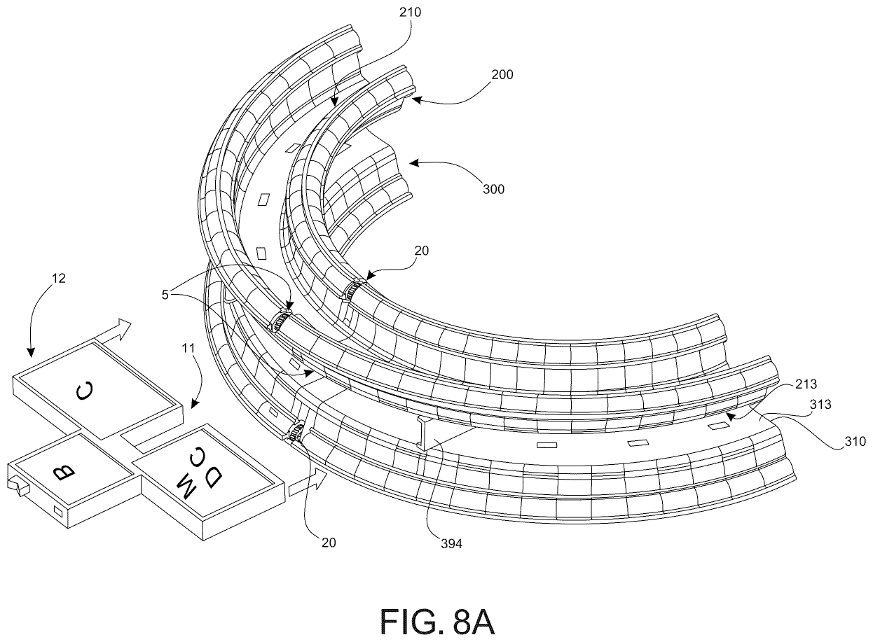

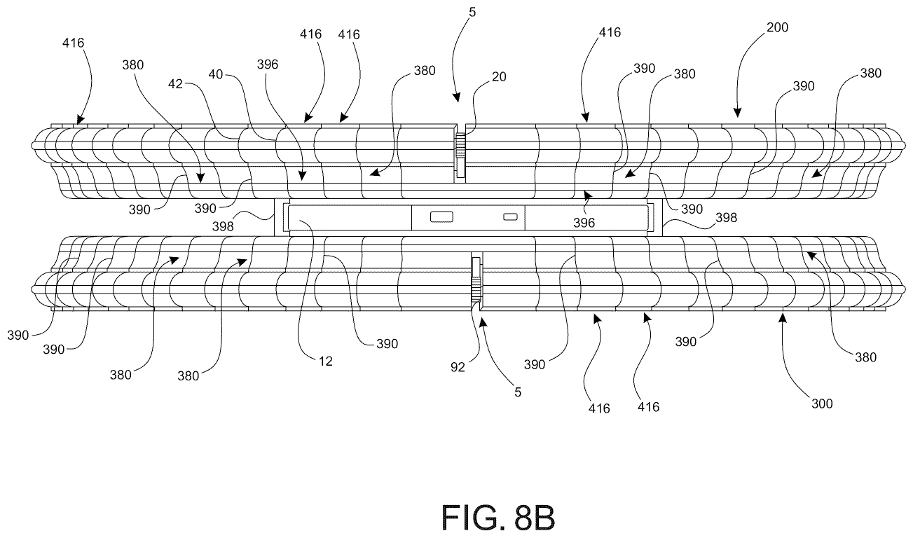

FIG. 8 demonstrates that the drums 40 are mounted along the first and second frames 200 and second frames 300 are rotationally enabled using minimum drive components 5 accomplishing the rotation in two directions, preferably toward the first base wall 210 and toward the third base wall 310, and also in reverse. Also shown is the third elevational arm 302 and the fourth elevational arm 304. While FIGS. 6 and 7 demonstrate the frame extending in the forward directions 231 and 232, the disclosed device may operate with just a single direction 231 or 232 or segment of the second, third, fourth and fifth shafts (30, 80, 90, 100) as disclosed.

FIG. 8A demonstrates the embodiment where the central frame 12 is removable. The first frame 200 and the second frame 300 may be mounted on one or more brackets 394, with the central frame 12 sliding along such bracket with the opening 11 sliding into and around the rotational components 5 to engage the central shaft (17). Alternatively, the central frame 12 may be the mountpoint for one or more frames 200 or 300. The connection points to the central frame 12 on the first frame 200 is preferably along the bottom surface 213 of the first base wall 210 and the connection points to the central frame 12 on the second frame 300 is preferably along the bottom surface 313 of the second base wall 310.

FIG. 8B demonstrates the first frame 200 and the second frame 300. It should be noted that what is shown to be the first frame 200 may be the second frame 300 and what is shown to be the second frame 300 may be the first frame 200 as the components are entirely reversible.

The rotational element 5 is shown from the front, with the remote wheel 20 of the first shaft (30) with the remote wheel 92 of the fourth shaft (90) visible. The central frame 12 may be inserted between the first and second frames 200 and 300, and in between the upright frames 398. Further visible in FIG. 8B are a plurality of individual sections 416. Each individual section 416 represents a drum 40, which may be removable and positioned in some sections, but not in others. Each individual section 416 is preferably terminated by intermediate arms 390, which extend from the connection point 380 until any of the shafts (30, 80, 90, 100). The fastener 396 connects the intermediate arm(s) 390 at the bottom end of the intermediate arm 390 so as to increase or decrease the angle of the intermediate arm 390 towards or away from the first or second base wall 210 or 310 such that a shaft may move over the first or second base wall 210 or 310 or away therefrom. In some embodiments the intermediate arms may also be adjusted laterally along the opposing edges (215) or (315). It is preferred that the gap 418 between the first or second first wall 210 or 310 remains empty so that excess brush compound, dirt and water can be easily cleared.

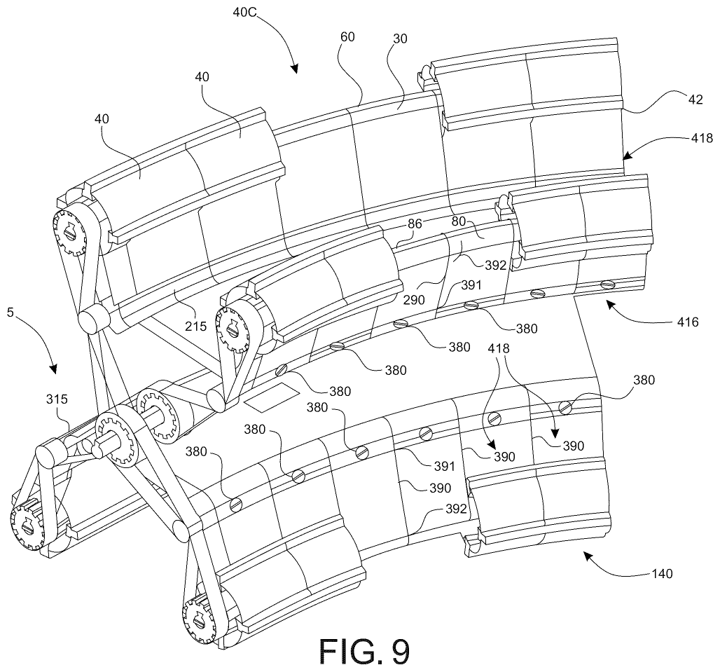

FIG. 9 demonstrates a plurality of drums 40 mounted onto the second, third, fourth and fifth shafts (30, 80, 90, 100) in a intermittent fashion, leaving gaps where brushing is not desired. The ability to remove and replace drums 40 helps to maintain the bristles in a proper operating condition. Furthermore, a user who is missing teeth in a certain area, or who may have had a dental procedure or injury in a particular area may not wish to have the area passed over by a rotating brush with bristles and will therefore, remove some of the rotating drums 40 leaving gaps 40c. The drums 40 are easily mounted on the second, third, fourth and fifth shafts (30, 80, 90, 100) over the protruding ridges 60 and 86, as shown.

Further shown in FIG. 9 are a plurality of attachment points 380 disposed along opposite edges 215 and 217 of the first base wall 210 and the opposite edges 315 and 317 of the second base wall 310. The intermediate arm 390 attaching to any one of the plurality of attachment points 380, with the intermediate arm 390 supporting the second shaft 30 along a point between the first or said second segments of said second shaft, or said intermediate arm supporting said third shaft along a point between first and second segments 250 and 252 of the second shaft 30, or the intermediate arm 390 may be supporting the fourth shaft 90 along a point between the first and second segments 350 and 352 of the fourth shaft 90, or the intermediate arm 390 may support the fifth shaft 100 along a point and the first and second segments 340 and 342 of the fifth shaft 100. The intermediate shaft 390 is preferably not a socket 52 but a post 391 having pincer clamps 392 so that a shaft is snaped into place in a rotational relationship between the pincer clamps 392. The attachment points utilize the fastener 382 to adjust the intermediate arm 390 in the direction (206) or (306). The individual sections 410 are preferably framed by an attachment point 380 at along the edge 215 or 315, the drum 40 and the intermediate arms 390. The space between the attachment point 380 and the drum 40 is preferably an empty gap.

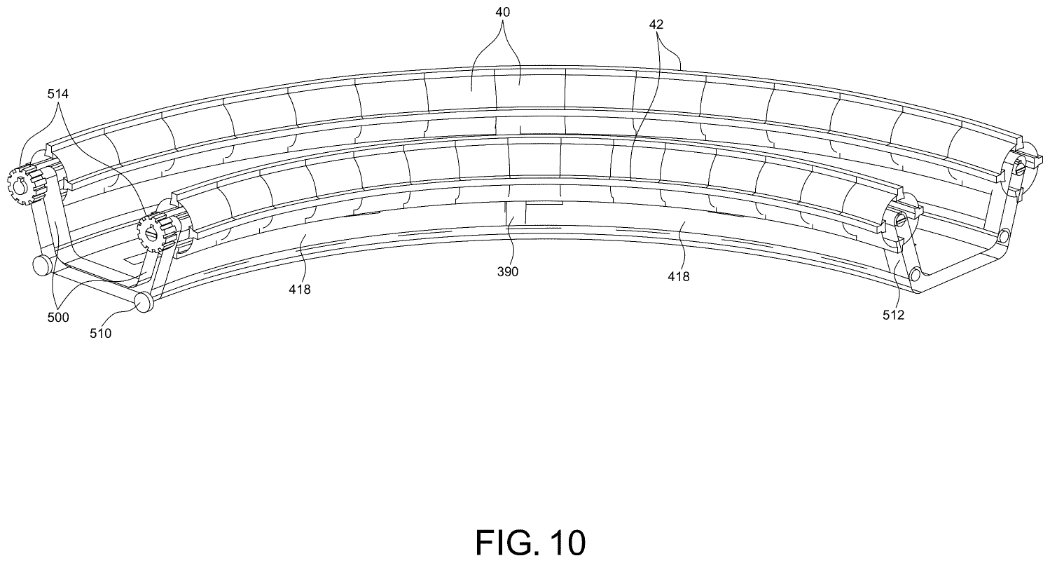

FIG. 10 shows a plurality of removable drums 40, having removable rows of bristles 42. To refresh or renew the hygienic effectiveness of the disclosed device, a user may replace the entire row of bristles 42 or a segment(s) of such row 42 representing just the worn out bristles. Also shown are elevational arms 500 which may be the first or second elevational arms 202 and 204 or third and fourth elevational arms 302 and 304. The gap 418 exists between the elevational arms 500 until the terminal point 510 (346) which is also an elevational arm that serves as the terminal end for the second, third, fourth or fifth shafts (30, 80, 90, 100). The gap 418 is intersected by one or more intermediate arms 390.

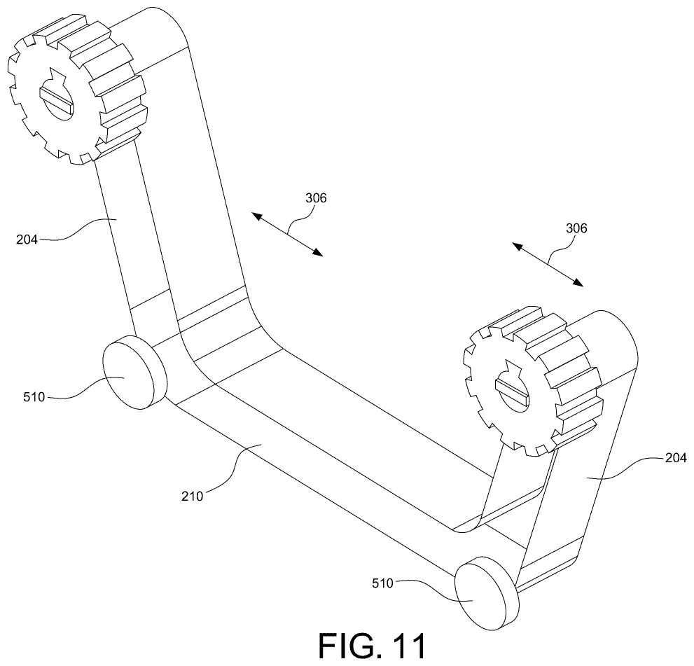

FIG. 11 demonstrates a closeup embodiment of the elevational arms 204, which may be the first, second, third or fourth elevational arms (202, 204, 302, 304). The spooling pins 510 assist with propelling or spooling a length of spool as it travels between the first shaft (17) and the second, third, fourth or fifth shafts (30, 80, 90, 100). The angle of the first, second, third or fourth elevational arms (202, 204, 302, 304) may be adjusted in the direction 306 or (206).

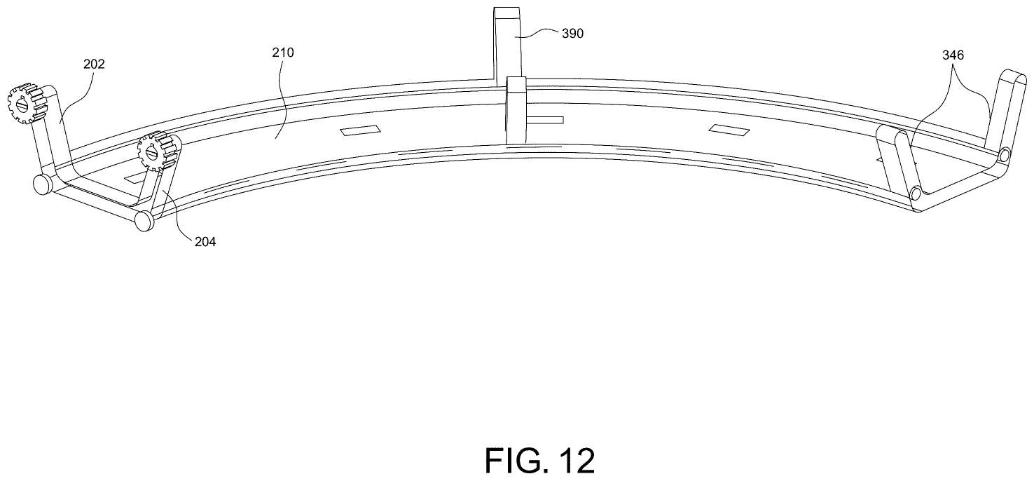

FIG. 12 demonstrates one section of either the first or the second frame 200 or (300) showing the first base wall 210 or (310), first elevational arm 202, the second elevational arm 204, the third elevational arm (302) or the fourth elevational arm (304) and intermediate arms 390, which may be one or a plurality along any given segment. The edges 215 or (315) house attachment point that control the angle of the elevational arms 390 with respect to the first base wall 210 or the third base wall (310).

Although this invention has been described with a certain degree of particularity, it is to be understood that the present disclosure has been made only by way of illustration and that numerous changes in the details of construction and arrangement of parts may be resorted to without departing from the spirit and the scope of the invention. While various inventive aspects, concepts and features of the inventions may be described and illustrated herein as embodied in combination in the exemplary embodiments, these various aspects, concepts and features may be used in many alternative embodiments, either individually or in various combinations and sub-combinations thereof. Unless expressly excluded herein all such combinations and sub-combinations are intended to be within the scope of the present inventions. Still further, while various alternative embodiments as to the various aspects, concepts and features of the inventions—such as alternative materials, structures, configurations, methods, devices and components, alternatives as to form, fit and function, and so on—may be described herein, such descriptions are not intended to be a complete or exhaustive list of available alternative embodiments, whether presently known or later developed. Those skilled in the art may readily adopt one or more of the inventive aspects, concepts or features into additional embodiments and uses within the scope of the present inventions even if such embodiments are not expressly disclosed herein. Additionally, even though some features, concepts or aspects of the inventions may be described herein as being a preferred arrangement or method, such description is not intended to suggest that such feature is required or necessary unless expressly so stated. Still further, exemplary or representative values and ranges may be included to assist in understanding the present disclosure, however, such values and ranges are not to be construed in a limiting sense and are intended to be critical values or ranges only if so expressly stated. Parameters identified as “approximate” or “about” a specified value are intended to include both the specified value and values within 10% of the specified value, unless expressly stated otherwise. Further, it is to be understood that the drawings accompanying the present disclosure may, but need not, be to scale, and therefore may be understood as teaching various ratios and proportions evident in the drawings. Moreover, while various aspects, features and concepts may be expressly identified herein as being inventive or forming part of an invention, such identification is not intended to be exclusive, but rather there may be inventive aspects, concepts and features that are fully described herein without being expressly identified as such or as part of a specific invention, the inventions instead being set forth in the appended claims, as currently written or as amended or added in the future. Descriptions of exemplary methods or processes are not limited to inclusion of all steps as being required in all cases, nor is the order that the steps are presented to be construed as required or necessary unless expressly so stated.

What is claimed:

1. A power toothbrush comprising; a central frame, said central frame having a at least one motor; each said at least one motor rotating a central shaft, said central shaft enabling rotation of second shaft in a direct connection using a rotating loop; said second shaft rotationally held within a first elevational arm said first elevational arm projecting out of said central frame wherein said second shaft having a first end and a second end; wherein a first end of said second shaft held within said first elevational arm, and wherein a length of said second shaft between said first end and said second end serving as a spindle for said at least one wheel; and at least one drum mounting on said length, a plurality of bristles projecting outwardly from an outward surface of said at least one drum.

2. The power toothbrush of claim 1, further comprising a first frame and a second frame, both said first frame and said second frame mounted on said central frame; said first frame having a first base wall; said first base wall supporting said first elevational arm and a second elevational arm, said first and said second elevational arms being in a parallel and spaced apart orientation with each other, separated by said first base wall, said first base wall extending laterally in the a first direction and in a second direction from said first and said first second elevational arms; wherein distal ends of said first base wall in said first direction and in said second direction being in parallel and spread apart association with each other; wherein a first segment of said second shaft extending from said first elevational arm until a terminal point along said first direction of said first base wall; wherein a second segment of said second shaft extending from said first elevational arm until a terminal point along said second direction of said first base wall; wherein a first segment of a third shaft extending from said second elevational arm until a terminal point along said first direction of said first base wall; wherein a second segment of said third shaft extending from said second elevational arm until a terminal point along said second direction of said first base wall; said second frame having a second base wall; said second base wall supporting a third elevational arm and a fourth elevational arm, said third and said fourth elevational arms being in a parallel and spaced apart orientation with each other, separated by said second base wall, said second base wall extending laterally in a first direction and in a second direction from said third and said fourth elevational arms; wherein distal ends of said second base wall in said first direction and in said second direction of said second base wall being in parallel and spread apart association with each other; wherein a first segment of a fourth shaft extending from said third elevational arm until a terminal point along said first direction of said second base wall; wherein a second segment of said fourth shaft extending from said third elevational arm until a terminal point along said second direction of said second base wall; wherein a first segment of a fifth shaft extending from said fourth elevational arm until a terminal point along said first direction of said second base wall; wherein a second segment of said fifth shaft extending from said fourth elevational arm until a terminal point along said second direction of said second base wall; wherein said first and said second frames in an inverted and stacked association with each other, wherein said first and said second elevational arms are extending in parallel and opposite direction from extension the third and fourth elevational arms; and a plurality of said at least one drum being selectively mounted along a length of said second shaft or said third shaft or said fourth shaft or said fifth shaft.

3. The power toothbrush of claim 2, wherein said second, said third, said fourth and said fifth shaft further comprising a remote wheel and wherein each one of said remote wheels rotationally coupled to said central shaft via a loop.

4. The power toothbrush of claim 2, wherein said first and said second segments of said second, said third, said fourth and said fifth shafts are made of an elastic or bendable material.

5. The power toothbrush of claim 2, wherein either said first segment and said second segment of said second shaft, or said third shaft, or said fourth shaft or said fifth shaft make ap a single shaft; or wherein said first and said second segments of said second, said third, said fourth and said fifth shafts are made from a plurality of sequentially connecting shafts.

6. The power toothbrush of claim 3, wherein said first and said second segments of said second, said third, said fourth and said fifth shafts are made of an elastic or bendable material, or wherein said first and said second segments of said second, said third, said fourth and said fifth shafts are made from a plurality of sequentially connecting shafts.

7. The power toothbrush of claim 2, wherein a sidewall of each of said at least one rotating drum is made of bendable or elastic material.

8. The power toothbrush of claim 6, wherein a sidewall of each of said at least one rotating drum is made of bendable or elastic material.

9. The power toothbrush of claim 1, wherein said central frame further comprising a power unit a controller unit and said at least one motor.

10. The power toothbrush of claim 2, wherein said central frame further comprising a power unit and said at least one motor.

11. The power toothbrush of claim 3, wherein said central frame further comprising a power unit and said at least one motor.

12. The power toothbrush of claim 2, wherein said second shaft and said third shaft are configured to rotate toward the first base wall, and wherein said fourth and said fifth shafts are configured to rotate towards said second base wall; wherein rotation of said second shaft and said third shaft toward the first base wall, and rotation of said fourth and said fifth shafts towards said second base wall rotates the at least one drum mounted thereon in the same direction and represents a gum saving rotation.

13. The power toothbrush of claim 2, wherein said second shaft and said third shaft are configured to rotate away from the first base wall, and wherein said fourth and said fifth shafts are configured to rotate away from said second base wall.

14. The power toothbrush of claim 2, wherein said central shaft further comprising a first central wheel and a second central wheel, wherein said first central wheel rotationally coupled to said at least one wheel on said second shaft and said at least one wheel on said fifth shaft by a rotating loop; and wherein said second central wheel rotationally coupled to said at least one wheel on said third shaft and said at least one wheel on said fourth shaft by a rotating loop.

15. The power toothbrush of claim 3, wherein said central shaft further comprising a first central wheel and a second central wheel, wherein said first central wheel rotationally coupled to said at least one wheel on said second shaft and said at least one wheel on said fifth shaft by a rotating loop; and wherein said second central wheel rotationally coupled to said at least one wheel on said third shaft and said at least one wheel on said fourth shaft by a rotating loop.

16. The power toothbrush of claim 1; wherein said at least one motor configured to enable continues rotation of said central shaft, or an intervaled rotation of said central shaft.

17. The power toothbrush of claim 3; wherein said at least one motor configured to enable continues rotation of said central shaft, or an intervaled rotation of said central shaft.

18. The power toothbrush of claim 14, wherein said second shaft and said third shaft are configured to rotate toward the first base wall, and wherein said fourth and said fifth shafts are configured to rotate towards said second base wall in a gum saving direction.

19. The power toothbrush of claim 14, wherein said second shaft and said third shaft are configured to rotate away from the first base wall, and wherein said fourth and said fifth shafts are configured to rotate away from said second base wall.

20. The power toothbrush of claim 2, further comprising at least one spool peg between said central shaft and said second, said third, said fourth, and said fifth shafts.

21. The power toothbrush of claim 15, further comprising at least one spool peg between said first central wheel and said second and said fifth shafts and between said second central wheel and between said third and said fourth shafts.

22. The power toothbrush of claim 2, further comprising a plurality of attachment points, wherein said plurality of attachment points disposed along opposite edges of said first base wall and said second base wall; an intermediate arm attaching to any one of said plurality of attachment points; said intermediate arm supporting said second shaft along a point between said first or said second segments of said second shaft, or said intermediate arm supporting said third shaft along a point between said first or said second segments of said third shaft, or said intermediate arm supporting said fourth shaft along a point between said first or said second segments of said fourth shaft, or said intermediate arm supporting said fifth shaft along a point between said first or said second segments of said fifth shaft; and wherein each attachment point configured to change an angle of said intermediate arm with respect to said first base wall or said second base wall.

23. The power toothbrush of claim 15, further comprising a plurality of attachment points, wherein said plurality of attachment points disposed along opposite edges of said first base wall and said second base wall; an intermediate arm attaching to any one of said plurality of attachment points; said intermediate arm supporting said second shaft along a point between said first or said second segments of said second shaft, or said intermediate arm supporting said third shaft along a point between said first or said second segments of said third shaft, or said intermediate arm supporting said fourth shaft along a point between said first or said second segments of said fourth shaft, or said intermediate arm supporting said fifth shaft along a point between said first or said second segments of said fifth shaft, and wherein each attachment point configured to change an angle of said intermediate arm with respect to said first base wall or said second base wall.

24. The power toothbrush of claim 23, further comprising at least one spool peg between said first central wheel and said second and said fifth shafts and between said second central wheel and between said third and said fourth shafts.

25. The power toothbrush of claim 2, wherein the central bracket is removable.

26. The power toothbrush of claim 23, wherein the central bracket is removable.

27. The power toothbrush of claim 2 wherein said second and said third and said fourth and said fifth shaft all further comprising at least one protruding ridge; wherein said at least one protruding ridge configured to removably mount said at least one remote wheel or said at least one drum.

28. The power toothbrush of claim 2, wherein said second and said third and said fourth and said fifth shaft all further comprising at least one protruding ridge; wherein said at least one protruding ridge configured to removably mount said at least one remote wheel or said at least one drum.

29. The power toothbrush of claim 15, wherein said second and said third and said fourth and said fifth shaft all further comprising at least one protruding ridge; wherein said at least one protruding ridge configured to removably mount said at least one remote wheel or said at least one drum.

30. The toothbrush of claim 1, wherein each said at least one drum supports a plurality of rows of bristles, wherein each such row of said bristles on any single at least one drum may be removed and replaced.
